(19) United States
(12) Patent Application Publication
(10) Pub. No.: US 2023/0327499 A1
(43) Pub. Date: Oct. 12, 2023

(54) CONTROL APPARATUS, CONTROL METHOD, AND NON-TRANSITORY COMPUTER READABLE RECORDING MEDIUM

(71) Applicant: TOYOTA JIDOSHA KABUSHIKI KAISHA, Aichi-ken (JP)

(72) Inventors: Ryosuke IKEMURA, Susono-shi (JP); Shogo TSUGE, Fuji-shi (JP); Toshiya HASHIMOTO, Miyoshi-shi (JP)

(21) Appl. No.: 18/298,389

(22) Filed: Apr. 11, 2023

(30) Foreign Application Priority Data
Apr. 12, 2022 (JP) 2022-065842

(51) Int. Cl. H02J 50/80; H02J 50/12; H02J 50/90; H02M 3/00; H02M 3/335

(52) U.S. Cl. CPC H02J 50/80; H02J 50/12; H02J 50/90; H02M 3/01; H02M 3/33573

(57) ABSTRACT

A control apparatus for a power transmitter which wirelessly transmits electric power to a power receiver, the power receiver being configured to perform restriction control that restricts received power through switching control under a predetermined condition. The control apparatus is configured to execute a determination process that determines whether or not the power receiver is performing the restriction control based on an output current and an output voltage of a power inverter included in the power transmitter, and a power control process that controls transmission power of the power transmitter based on a result of the determination process.

### CROSS-REFERENCE TO RELATED APPLICATION

The present application claims priority under 35 U.S.C. § 119 to Japanese Patent Application No. 2022-065842, filed Apr. 12, 2022, the contents of which application are incorporated herein by reference in their entirety.

### BACKGROUND

### Technical Field

The present disclosure relates to a technique for controlling a power transmitter which wirelessly transmits electric power to a power receiver.

### Background Art

In recent years, there has been proposed a wireless power transmission system in which a power transmitter wirelessly transmits electric power to a power receiver. Regarding the wireless power transmission system, in order to protect the power receiver or batteries from occurrence of overvoltage or the like due to an excessive increase in received power, a technique for restricting the received power by switching control has been considered.

Patent Literature 1 discloses a wireless power receiving device comprising a power receiving side resonant circuit provided with a power receiving coil wirelessly receiving electric power from a power feeding side and a power receiving side resonant capacitor connected to the power receiving coil, a rectifier circuit in which the electric power received by the power receiving coil is rectified to be output to a load, a power receiving side voltage detecting portion for detecting an output voltage of the rectifier circuit, a short circuit provided with a switching element connected between an output portion of the power receiving side resonant circuit and an output portion of the rectifier circuit, and a controlling circuit which operates the switching element when a value of the output voltage detected by the power receiving side voltage detecting portion exceeds a preset reference voltage value.

### LIST OF RELATED ART

Patent Literature 1: JP 6361818 B2

### SUMMARY

When the switching control is performed for a long time, the switching loss increases and the power efficiency decreases. In addition, the heat loss of switching devices increases, resulting in higher costs due to the enlargement of a cooling device, or the like. Therefore, it is desirable to reduce the period of the switching control for restricting the received power. In order to reduce the period of the switching control in the power receiver, it is conceivable to control the transmission power of the power transmitter depending on the state of the power receiver. However, depending on the situation to which the wireless power transmission system is applied, it may be difficult for the power transmitter to always communicate with the power receiver, and the power transmitter may not be able to appropriately acquire the state of the power receiver.

In the view of the above-described problem, an object of the present disclosure is to provide a technique capable of controlling transmission power of the power transmitter depending on the state of the power receiver without requiring continuous communication with the power receiver.

A first disclosure is directed to a control apparatus for a power transmitter which wirelessly transmits electric power to a power receiver, the power receiver being configured to perform restriction control that restricts received power through switching control under a predetermined condition.

The control apparatus is configured to execute:
a determination process that determines whether or not the power receiver is performing the restriction control based on an output current and an output voltage of a power inverter included in the power transmitter; and
a power control process that controls transmission power of the power transmitter based on a result of the determination process.

A second disclosure is directed to a control apparatus having the following features with respect to the control apparatus according to the first disclosure.

The determination process comprises:
calculating an amplitude ratio and a phase difference between the output current and the output voltage; and
determining that the power receiver is performing the restriction control when a coordinate position represented by a pair of the amplitude ratio and the phase difference is outside a predetermined range.

A third disclosure is directed to a control apparatus having the following features with respect to the control apparatus according to the second disclosure.

The control apparatus according to the third disclosure is further configured to execute:
a process that acquires specification information and identification information of the power receiver predicted to become a power transmission target; and
a process that identifies the power receiver being the power transmission target based on the identification information before starting power transmission.

The determination process further comprises determining the predetermined range based on the specification information of the identified power receiver.

A fourth disclosure is directed to a control apparatus having the following features with respect to the control apparatus according to any one of the first to third disclosures.

The power control process comprises performing control to reduce the transmission power when it is determined that the power receiver is performing the restriction control.

A fifth disclosure is directed to a control method for controlling a power transmitter which wirelessly transmits electric power to a power receiver, the power receiver being configured to perform restriction control that restricts received power through switching control under a predetermined condition.

The control method comprises:
determining whether or not the power receiver is performing the restriction control based on an output current and an output voltage of a power inverter included in the power transmitter; and
controlling transmission power of the power transmitter based on a result of the determining whether or not the power receiver is performing the restriction control.

A sixth disclosure is directed to a control method having the following features with respect to the control apparatus according to the fifth disclosure.

The determining whether or not the power receiver is performing the restriction control comprises:
calculating an amplitude ratio and a phase difference between the output current and the output voltage; and
determining that the power receiver is performing the restriction control when a coordinate position represented by a pair of the amplitude ratio and the phase difference is outside a predetermined range.

A seventh disclosure is directed to a control program for controlling a power transmitter which wirelessly transmits electric power to a power receiver, the power receiver being configured to perform restriction control that restricts received power through switching control under a predetermined condition.

The control program, when executed by a computer, causes the computer to execute:
a determination process that determines whether or not the power receiver is performing the restriction control based on an output current and an output voltage of a power inverter included in the power transmitter; and
a power control process that controls transmission power of the power transmitter based on a result of the determination process.

An eighth disclosure is directed to a control program having the following features with respect to the control program according to the seventh disclosure.

The determination process comprises:
calculating an amplitude ratio and a phase difference between the output current and the output voltage; and
determining that the power receiver is performing the restriction control when a coordinate position represented by a pair of the amplitude ratio and the phase difference is outside a predetermined range.

A ninth disclosure is directed to a wireless power transmission system.

The wireless power transmission system comprises a power receiver configured to perform restriction control that restricts received power through switching control under a predetermined condition, a power transmitter which wirelessly transmits electric power to the power receiver, one or more processors, and a memory.

The memory stores executable instructions that, when executed by the one or more processors, cause the one or more processors to execute:
a determination process that determines whether or not the power receiver is performing the restriction control based on an output current and an output voltage of a power inverter included in the power transmitter; and
a power control process that controls transmission power of the power transmitter based on a result of the determination process.

A tenth disclosure is directed to a wireless power transmission system having the following features with respect to the wireless power transmission system according to the ninth disclosure.

The determination process comprises:
calculating an amplitude ratio and a phase difference between the output current and the output voltage; and
determining that the power receiver is performing the restriction control when a coordinate position represented by a pair of the amplitude ratio and the phase difference is outside a predetermined range.

According to the present disclosure, it is determined whether or not the power receiver is performing the restriction control based on the output current and the output voltage of the power inverter included in the power transmitter. Then, the transmission power of the power transmitter is controlled based on a result of the determination. It is thus possible to determine whether or not the power receiver is performing the restriction control and to control the transmission power without continuous communication with the power receiver. Consequently, it is possible to reduce the period during which the power receiver performs the restriction control. Furthermore, it is possible to reduce a decrease in power efficiency and a heat loss caused by the switching control. And it is possible to achieve cost reduction and downsizing of the power receiver.

### BRIEF DESCRIPTION OF DRAWINGS

FIG. 1 is a circuit diagram showing a configuration example of a wireless power transmission system according to the present embodiment;

FIG. 2 is a conceptual diagram for explaining the restriction control by PWM control;

FIG. 3 is a conceptual diagram showing an example in which the wireless power transmission system is applied to a charging system that charges the battery mounted on a vehicle;

FIG. 4 is a graph showing an example of an output current and an output voltage of a power inverter;

FIG. 5 is a graph showing an example of a two-dimensional plot of a pair of an amplitude ratio and a phase difference when increasing a duty in the PWM control;

FIG. 6 is a conceptual diagram showing an example in which a process for determining a predetermined range in the case shown in FIG. 3;

FIG. 7 is a flowchart showing processes executed by a power transmission control apparatus according to the present embodiment;

FIG. 8 is a block diagram showing a schematic configuration of a power transmission control apparatus according to the present embodiment.

### EMBODIMENTS

Hereinafter, an embodiment of the present disclosure will be described with reference to the drawings. Note that when the numerals of the numbers, the quantities, the amounts, the ranges and the like of the respective elements are mentioned in the embodiments shown as follows, the present disclosure is not limited to the mentioned numerals unless specially explicitly described otherwise, or unless the invention is explicitly specified by the numerals theoretically. Furthermore, structures or the like that are described in conjunction with the following embodiment is not necessarily essential to the concept of the present disclosure unless explicitly described otherwise, or unless the present disclosure is explicitly specified by the structures or the like theoretically. Note that in the respective drawings, the same or corresponding parts are assigned with the same reference signs, and redundant explanations of the parts are properly simplified or omitted.

### 1. Wireless Power Transmission System

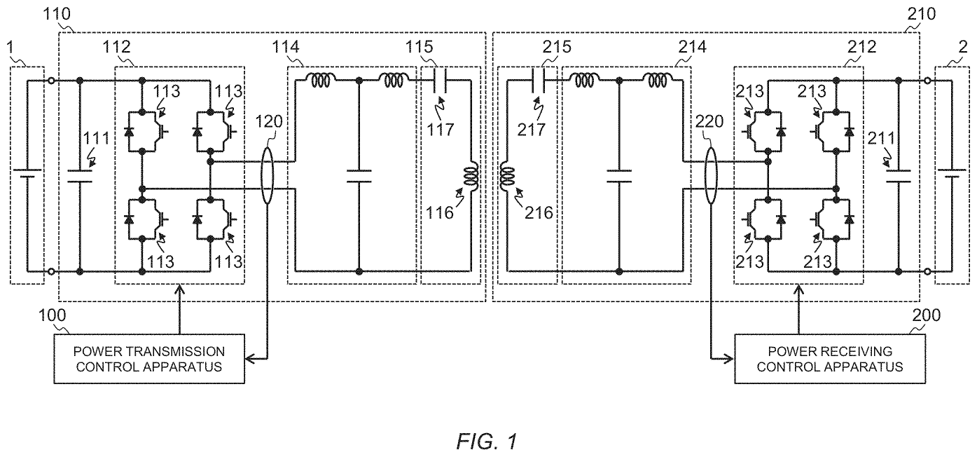

The present embodiment relates to a wireless power transmission system in which a power transmitter wirelessly transmits electric power to a power receiver. FIG. 1 is a circuit diagram showing a configuration example of the wireless power transmission system according to the present embodiment. FIG. 1 shows a case where the wireless power transmission system is applied to a charging system which charges a battery 2 with electric power supplied from a DC power supply 1. The DC power supply 1 supplies electric power to a power transmitter 110. And the power transmitter 110 wirelessly transmits electric power to a power receiver 210. Then, the battery 2 is charged with received power of the power receiver 210.

The DC power supply 1 and the power transmitter 110 are typically placed on the ground, floor, wall or the like. The power receiver 210 and the battery 2 are typically mounted on a moving object to be charged such as a portable device, a vehicle, or the like. The battery 2 is typically a rechargeable battery such as a lithium-ion battery, a nickel-metal hydride battery, or the like.

In the wireless power transmission system shown in FIG. 1, a transmitter coil 116 included in the power transmitter 110 and a receiver coil 216 included in the power receiver 210 magnetically resonate with each other. Then, electric power is transmitted from the transmitter coil 116 to the receiver coil 216. That is, in the wireless power transmission system according to the present embodiment, power transmission is performed by resonant inductive coupling.

The power transmitter 110 comprises a smoothing capacitor 111, a power inverter 112, a filter circuit 114, and a power transmission circuit 115. The power inverter 112, the filter circuit 114, and the power transmission circuit 115 are configured to be connected in cascaded connection.

The power inverter 112 converts DC power into AC power. And the power inverter 112 outputs the converted power. The output power of the power inverter 112 is supplied to the power transmission circuit 115 through the filter circuit 114.

The power inverter 112 is a single-phase full-bridge circuit including switching devices 113. The power inverter 112 is connected to the power transmission control apparatus 100. The power transmission control apparatus 100 performs switching control of the switching devices 113 based on information acquired from a measuring device 120. Examples of the measuring device 120 include an ammeter, a voltmeter, or the like. By the power transmission control apparatus 100 performing the switching control, the frequency and amplitude of the output power of the power inverter 112 are controlled. Consequently, transmission power of the power transmitter 110 is controlled. In particular, the frequency of the output power of the power inverter 112 are adjusted to be equivalent to the resonant frequency of the power transmission circuit 115. In this sense, the resonance frequency of the power transmission circuit 115 can also be referred to as a “drive frequency”. The information that the power transmission control apparatus 100 acquires from the measuring device 120 includes at least an output current and an output voltage of the power inverter 112.

The filter circuit 114 reduces electromagnetic noise of the output power of the power inverter 112. The filter circuit 114 is composed of coils and a capacitor. And the filter circuit 114 functions as a low-pass filter. And the impedance of the power transmitter 110 is adjusted by the filter circuit 114.

The power transmission circuit 115 is a resonance circuit including the transmitter coil 116 and a resonance capacitor 117. By the power inverter 112 supplying electric power with the resonant frequency to the power transmission circuit 115, the transmitter coil 116 magnetically resonate with the receiver coil 216. As a result, electric power is transmitted from the transmitter coil 116 to the receiver coil 216.

The power receiver 210 includes a smoothing capacitor 211, an active rectifier 212, a filter circuit 214, and a power receiving circuit 215. The active rectifier 212, the filter circuit 214, and the power receiving circuits 215 are configured to be connected in cascade connection.

The power receiving circuit 215 is a resonance circuit including the receiver coil 216 and a resonance capacitor 217. The resonance frequency of the power receiving circuit 215 is configured to be equal to the resonance frequency of the power transmission circuit 115. The receiver coil 216 magnetically resonate with the transmitter coil 116. Then, the receiver coil 216 receives electric power transmitted from the transmitter coil 116.

The filter circuit 214 reduces electromagnetic noise of electric power received by the power receiving circuit 215. The filter circuit 214 is composed of coils and a capacitor. And the filter circuit 214 functions as a low-pass filter. And the impedance of the power receiver 210 is adjusted by the filter circuit 214.

The active rectifier 212 converts electric power received by the power receiving circuit 215 into DC power. And the active rectifier 212 outputs the converted power. The output power of the active rectifier 212 is supplied to the battery 2 through the smoothing capacitor 211. That is, the output power of the active rectifier 212 is received power of the power receiver 210.

The active rectifier 212 is a single-phase bridge rectifier circuit including switching devices 213. The active rectifier 212 is connected to a power receiving control apparatus 200. The power receiving control apparatus 200 performs switching control of the switching devices 213 based on information acquired from a measuring device 220. By the power receiving control apparatus 200 performing the switching control, the output power of the active rectifier 212 (the received power of the power receiver 210) is controlled.

More specifically, by the power receiving control apparatus 200 performing the switching control of switching on/off of the switching devices 213, a short circuit is temporarily formed in the active rectifier 212. When forming the short circuit, the output power of the active rectifier 212 is hardly supplied to the battery 2. Therefore, by temporarily forming the short circuit through the switching control, it is possible to restrict the output power of the active rectifier 212 (the received power of the power receiver 210). That is, the power receiving control apparatus 200 performs “restriction control” that restricts the received power through the switching control. When performing the restriction control, it can be said that the power receiver 210 is in “short circuit mode” since the short circuit is temporarily formed.

The power receiving control apparatus 200 typically performs the restriction control for the purpose of protecting the power receiver 210 and the battery 2. Therefore, the restriction control is typically performed to refrain from the received power exceeding an upper limit determined by the power rating of the power receiver 210 or the battery 2. For example, the power receiving control apparatus 200 performs the restriction control when the received power exceeds the upper limit or is predicted to exceed the upper limit.

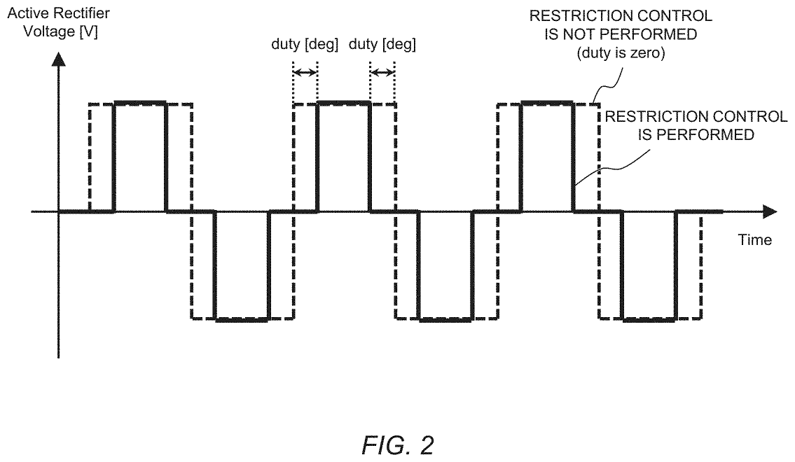

The power receiving control apparatus 200 may be configured to perform the restriction control by PWM control. In this case, how long the short circuit is formed is determined by the duty in the PWM control. FIG. 2 shows an example of the voltage of the active rectifier 212 when the restriction control by the PWM control is performed. FIG. 2 shows a graph (dashed line) when the restriction control is not performed and a graph (solid line) when the restriction control by the PWM control is performed. As shown in FIG. 2, when the restriction control by the PWM control is performed, the period in which the short circuit is formed is determined by the duty in the PWM control. That is, by increasing the duty, the restriction of the received power can be further strengthened.

As described above, the wireless power transmission system according to the present embodiment is configured. The wireless power transmission system shown in FIG. 1 is configured that the DC power supply 1 supplies electric power to the power transmitter 110. But the wireless power transmission system may be configured that an AC power supply supplies electric power to the power transmitter 110. In this case, by providing a converter at the input stage of the power transmitter 110, a configuration similar to that of FIG. 1 can be achieved.

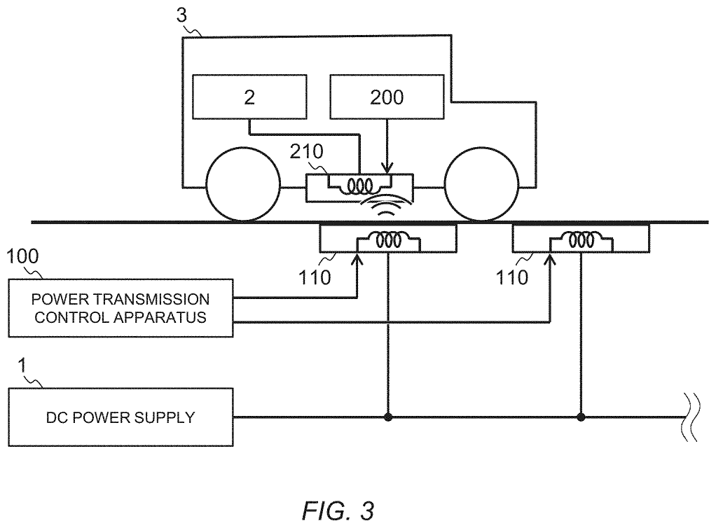

The wireless power transmission system according to the present embodiment may include a plurality of the power transmitters 110 or a plurality of the power receivers 210. For example, the wireless power transmission system may be applied to a charging system that charges the battery 2 mounted on a vehicle while the vehicle is traveling. FIG. 3 shows an example in which the wireless power transmission system is applied to the charging system that charges the battery 2 while the vehicle 3 is traveling. In the example shown in FIG. 3, when the vehicle 3 passes through a plurality of the power transmitters 110 arranged in series on the travel path of the vehicle 3, the power receiver 210 mounted on the vehicle 3 wirelessly receives electric power and charges the battery 2. Although two power transmitters 110 are shown in FIG. 3, more power transmitters 110 may be arranged over a longer distance. In this case, considering that there may be a plurality of similar vehicles 3, the wireless power transmission system includes a plurality of the power receivers 210.

When the restriction control is performed in the power receiver 210 for a long period of time, switching loss associated with the switching control increases, and power efficiency decreases. Furthermore, since the heat loss of switching devices increases, resulting in higher costs due to the enlargement of a cooling device, or the like. Therefore, it is desirable to reduce the period during which the restriction control is performed in the power receiver 210.

In order to reduce the period during which the restriction control is performed in the power receiver 210, it is conceivable to control the transmission power of the power transmitter 110 depending on the state of the power receiver 210. However, depending on the situation to which the wireless power transmission system is applied, it may be difficult for the power transmitter 110 to always communicate with the power receiver 210, and the power transmitter 110 may not be able to appropriately acquire the state of the power receiver 210. For example, in the example shown in FIG. 3, it is assumed that a period during which one power transmitter 110 performs power transmission is very short. Therefore, if the state of the power receiver 210 is acquired by communication, a delay in control cannot be ignored.

The inventors of the present disclosure have found that it is possible to determine whether or not the power receiver 210 is performing the restriction control based on a characteristic of the output current and the output voltage of the power inverter 112. Utilizing this characteristic, the wireless power transmission system according to the present embodiment has a feature in processes executed by the power transmission control apparatus 100. The characteristic of the output current and the output voltage of the power inverter 112 will be described below. Then, the processes executed by the power transmission control apparatus 100 according to the present embodiment will be described.

### 2. Characteristic of Output Current and Output Voltage of Power Inverter

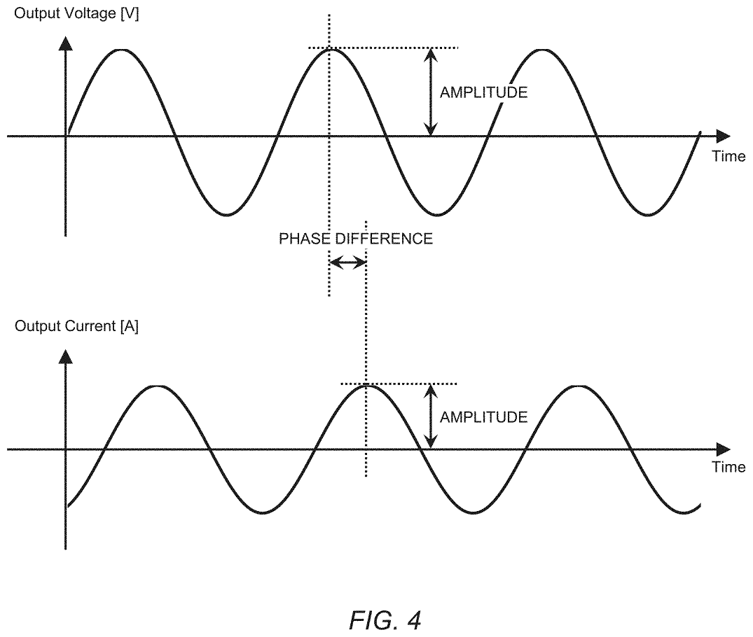

As shown in FIG. 4, the output current and the output voltage of the power inverter 112 have different amplitudes and phases depending on the impedance of the power transmitter 110 and the power receiver 210. Therefore, regarding the output current and the output voltage of the power inverter 112, an amplitude ratio and a phase difference can be given. In the following description, the amplitude ratio is a ratio of the amplitude of the output voltage to the amplitude of the output current (the amplitude of the output voltage/the amplitude of the output current). The amplitude ratio may be referred to as a “gain”. That is, the unit of the gain is Ω.

The inventors according to the present disclosure have focused on the fact that the two-dimensional plot of a pair of the gain and the phase difference draws a specific curve when increasing the duty in the PWM control under the condition that the coupling coefficient between the transmitter coil 116 and the receiver coil 216 is constant (e.g., the relative positions of the power transmitter 110 and the power receiver 210 are constant).

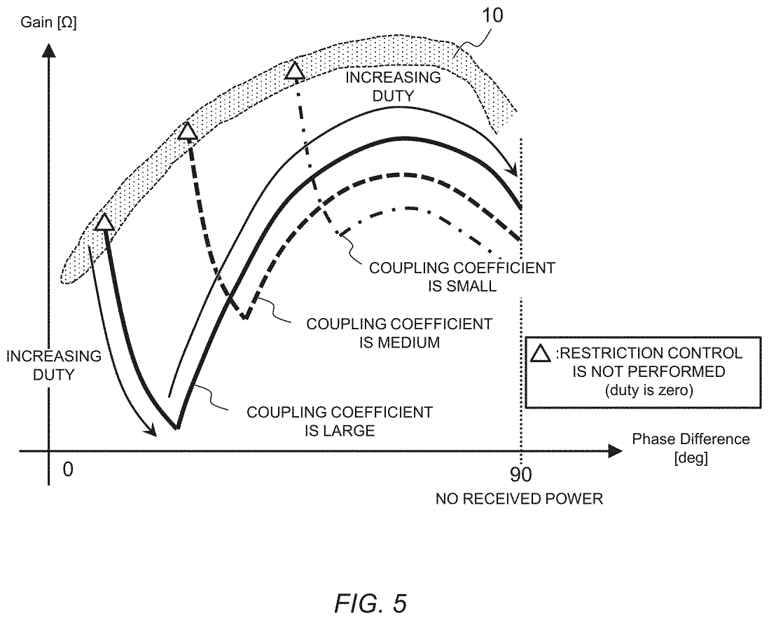

FIG. 5 shows an example of the two-dimensional plot of the pair of the gain and the phase difference when increasing the duty for three cases where the coupling coefficient differs from each other (large (solid line), medium (dashed line line), and small (chain line)). As shown in FIG. 5, the two-dimensional plot of the pair of the gain and the phase difference when increasing the duty draws a specific curve. The specific curve is determined by electronic circuit information of the power transmitter 110 and the power receiver 210. Examples of the electronic circuit information include a circuit configuration, a drive frequency, inductances of the transmitter coil 116 and the receiver coil 216, a resistance value, a capacitance value, a power supply voltage, and the like. Note that the shape of the specific curve is different depending on the coupling coefficient. It is generally assumed that the coupling coefficient constantly changes in the wireless power transmission system.

On the other hand, the inventors of the present disclosure have found that a predetermined range 10 can be defined by a set of points when the duty is zero (points when the restriction control is not performed, illustrated by triangle marks in FIG. 5) each of which is a starting point of each specific curve. Here, the predetermined range 10 may be determined in consideration of a range of a measurement error. The predetermined range 10 does not depend on the coupling coefficient because of its definition. In addition, the specific curve drawn by the two-dimensional plots of the pair of the gain and the phase difference is determined by the electronic circuit information of the power transmitter 110 and the power receiver 210. That is, the predetermined range 10 can be uniquely determined by the pair of the power transmitter 110 and the power receiver 210. For example, the predetermined range 10 as shown in FIG. 5 can be managed in advance as mapping information.

Determining the predetermined range 10, it is possible to determine whether or not the power receiver 210 is performing the restriction control based on the output current and the output voltage of the power inverter 112. That is, when a coordinate position of the pair of the gain and the phase difference is outside the predetermined range 10, it can be determined that the power receiver 210 is performing the restriction control.

Utilizing the characteristic described above, the power transmission control apparatus 100 according to the present embodiment executes a determination process that determines whether or not the power inverter 112 is performing the restriction control based on the output current and the output voltage of the power inverter 112. The power transmission control apparatus 100 can acquire the output current and the output voltage of the power inverter 112 from the power transmitter 110. Therefore, it is possible to determine whether or not the power receiver 210 is performing the restriction control and control the transmission power without requiring continuous communication with the power receiver 210.

In a case where the wireless power transmission system includes a plurality of the power transmitters 110 or a plurality of the power receivers 210, it is assumed that the predetermined range 10 differs depending on a pair of the power transmitter 110 and the power receiver 210. Therefore, the power transmission control apparatus 100 according to the present embodiment may be configured to execute the following process.

First, the power transmission control apparatus 100 executes a process that acquires specification information and identification information of the power receiver 210 predicted to become a power transmission target. The specification information includes the electronic circuit information of the power receiver 210. The identification information is, for example, identification number linked to each of the plurality of the power receivers 210. Alternatively, the identification information is identification number linked to each of a plurality of moving objects on which the power receiver 210 is mounted. The power transmission control apparatus 100 manages the specification information and the identification information in association with each other. The power transmission control apparatus 100 may acquire these information through a wide-range communication when the power transmitter 110 and the power receiver 210 are separated from each other.

Next, the power transmission control apparatus 100 executes a process that identifies the power receiver 210 being the power transmission target based on the identification information acquired in advance before starting power transmission. For example, when any one of the plurality of the power receivers 210 is in the vicinity of the power transmitter 110, the power transmission control apparatus 100 acquires the identification number from the one power receiver 210. And the power transmission control apparatus 100 identifies the one power receiver 210 as the power transmission target by checking the identification number acquired from the one power receiver 210 with the identification number acquired in advance. In this case, the power transmission control apparatus 100 may acquire the identification information from the one power receiver 210 through a short-range communication. By identifying the power receiver 210 being the power transmission target in this way, the power transmission control apparatus 100 can refer to the specification information of the power receiver 210 being the power transmission target simply by communicating for the identification information.

Next, in the determination process, the power transmission control apparatus 100 determines the predetermined range 10 based on the specification information of the identified power receiver 210. For example, the power transmission control apparatus 100 refers to the specification information using the identification information of the identified power receiver 210. And the power transmission control apparatus 100 defines the predetermined range 10 by calculating a two-dimensional plot of the pair of the gain and the phase difference based on the specification information of the identified power receiver 210 and the specification information of the power transmitter 110.

By the power transmission control apparatus 100 executing the process described above, even in a case where the wireless power transmission system includes a plurality of the power transmitters 110 or a plurality of the power receivers 210, it is possible to manage the predetermined range 10 regarding the power receiver 210 being the power transmission target in advance before starting power transmission. As a result, it is possible to determine whether or not the power receiver 210 is performing the restriction control and control the transmission power without requiring continuous communication with the power receiver 210.

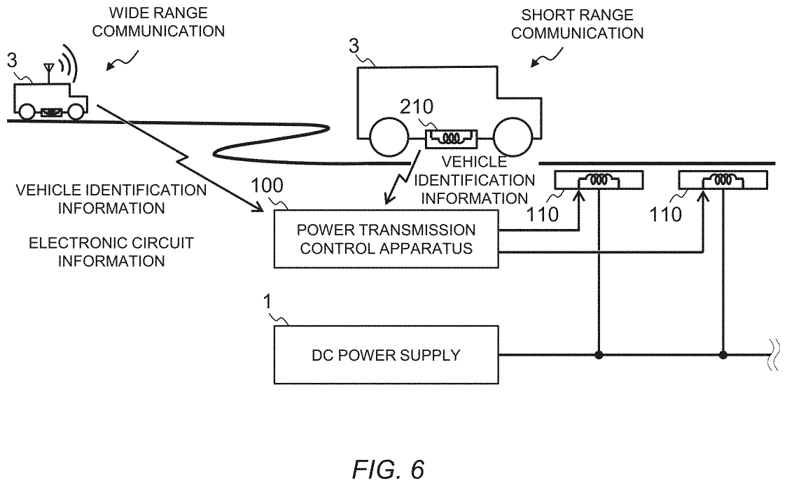

FIG. 6 is a conceptual diagram showing an example in which the power transmission control apparatus 100 performs the process described above in the case shown in FIG. 3. In the example shown in FIG. 6, the power transmission control apparatus 100 first performs wide-range communication with a vehicle 3 predicted to travel on a road on which a plurality of the power transmitters 110 are arranged in series (e.g., predicted from a travel plan of the vehicles 3). And the power transmission control apparatus 100 acquires vehicle identification information of the vehicles 3 as the identification information and electronic circuit information of the power receiver 210 included in the vehicles 3 as the specification information. Examples of the wide-range communication include wireless broadband communication such as LTE, 4G, or the like. Next, when the vehicle 3 approaches one of the plurality of the power transmitters 110, the power transmission control apparatus 100 performs short-range communication with the vehicle 3. And the power transmission control apparatus 100 acquires the vehicle identification information. The power transmission control apparatus 100 can identify the power receiver 210 being the power transmission target by checking the vehicle identification information acquired through the short-range communication. And the power transmission control apparatus 100 can acquire the electronic circuit information of the power receiver 210 being the power transmission target. The short-range communication is realized, for example, using Radio-frequency identification technique. Next, the power transmission control apparatus 100 determines the predetermined range 10 for the power receiver 210 being the power transmission target and starts power transmission.

### 3. Processes Executed by Power Transmission Control Apparatus

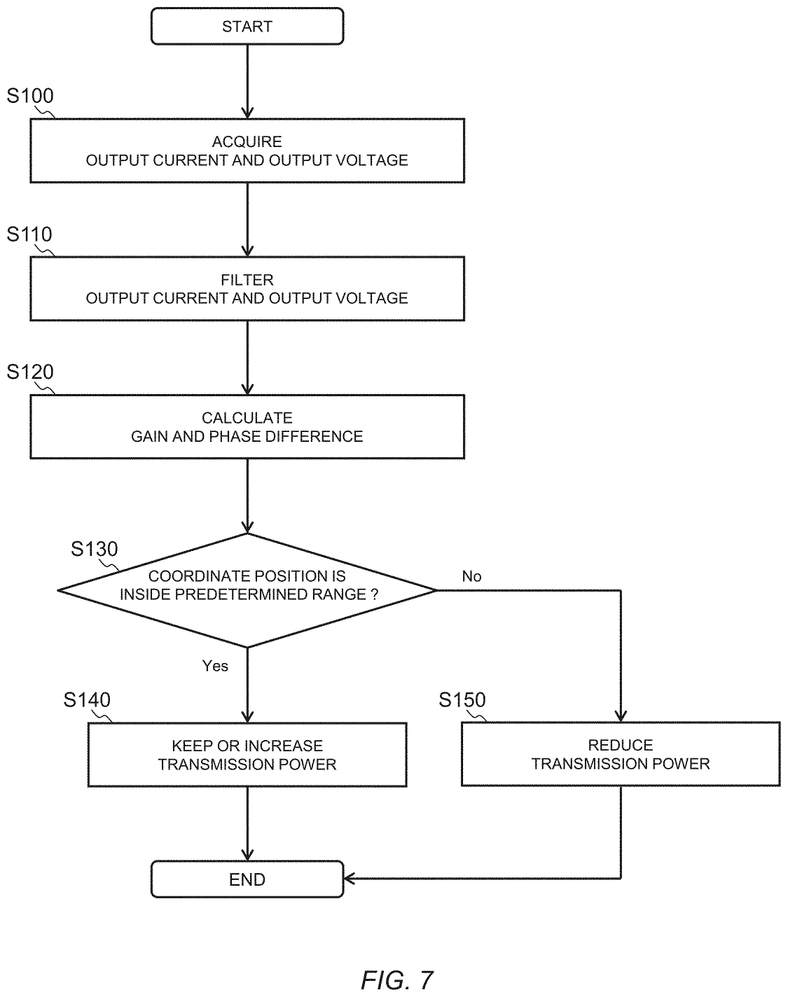

In the following, processes executed by the power transmission control apparatus 100 according to the present embodiment will be described with reference to FIG. 7. FIG. 7 is a flowchart showing the processes executed by the power transmission control apparatus 100 according to the present embodiment. The flowchart shown in FIG. 7 is repeatedly executed at a predetermined processing cycle for the target power receiver 210 being the power transmission target. In the following description, it is assumed that the predetermined range 10 for the power receiver 210 being the power transmission target is determined and managed in advance.

In step S100, the power transmission control apparatus 100 acquires the output current and the output voltage of the power inverter 112 from the measuring device 120.

After step S100, the process proceeds to step S110.

In step S110, the power transmission control apparatus 100 filters the output current and the output voltage acquired in step S100. Thus, the fundamental wave components of the output current and the output voltage are extracted. The filtering process may employ a known suitable technique.

After step S110, the process proceeds to step S120.

In step S120, the power transmission control apparatus 100 calculates the gain and the phase difference between the output current and the output voltage.

After step S120, the process proceeds to step S130.

In step S130 (determination process), the power transmission control apparatus 100 determines whether or not the coordinate position of the pair of the gain and the phase difference calculated in step S120 is inside the predetermined range 10. That is, the power transmission control apparatus 100 determines whether or not the power receiver 210 is performing the restriction control. The power transmission control apparatus 100 executes a power control process that controls the transmission power of the power transmitter 110 based on the result of the determination in step S130.

When the coordinate position of the pair of the gain and the phase difference is inside the predetermined range 10 (step S130; Yes), that is, when it is determined that the power receiver 210 does not perform the restriction control, the power transmission control apparatus 100 performs the switching control of the power inverter 112 to keep or increase the transmission power (step S140). When the coordinate position of the pair of the gain and the phase difference is outside the predetermined range 10 (step S130; No), that is, when it is determined that the power receiver 210 is performing the restriction control, the power transmission control apparatus 100 performs the switching control of the power inverter 112 to reduce the transmission power (step S150).

As described above, the power transmission control apparatus 100 executes the processes. And, by the power transmission control apparatus 100 executing the processes described above, a control method for controlling the power transmitter 110 according to the present embodiment is realized. Furthermore, a control program causing the power transmission control apparatus 100 to execute the processes described above can be realized.

### 4. Configuration of Power Transmission Control Apparatus

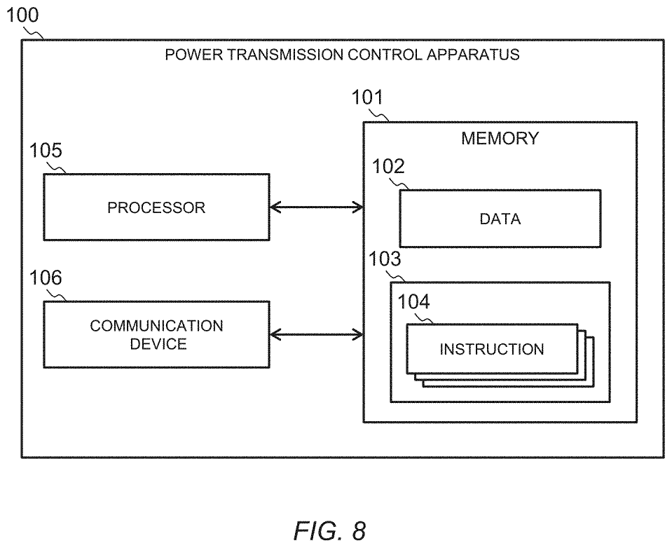

In the following, a configuration of the power transmission control apparatus 100 according to the present embodiment will be described with reference to FIG. 8. FIG. 8 is a block diagram showing a schematic configuration of the power transmission control apparatus 100 according to the present embodiment. The power transmission control apparatus 100 is a computer including a memory 101, a processor 105, and a communication device 106. The memory 101 is coupled to the processor 105, and stores executable instructions 104 and various data 102 required to perform processes. The instructions 104 are provided by a control program 103. In this sense, the memory 101 may also be referred to as “program memory”. The memory 101 may include a non-transitory computer readable recording medium on which the control program 103 is recorded. Examples of the data 102 stored in the memory 101 include mapping information that gives the predetermined range 10.

The communication device 106 transmits/receives information to/from devices external to the power transmission control apparatus 100. For example, the communication device 106 performs wide-range communication or short-range communication with the vehicle 3. Examples of information received by the communication device 106 include the output current and the output voltage of the power inverter 112 and the specification information and the identification information of the power receiver 210. The power transmission control apparatus 100 may acquire mapping information that gives the predetermined range 10 via the communication device 106. Information received by the communication device 106 is stored in the memory 101 as the data 102.

The instructions 104 are configured to cause the processor 105 to execute the processes shown in FIG. 7. That is, when the processor 105 operates in accordance with the instructions 104, the execution of the processes shown in FIG. 7 is realized.

### 5. Effect

As described above, according to the present embodiment, it is determined whether or not the power receiver 210 is performing the restriction control based on the output current and the output voltage of the power inverter 112. Then, the transmission power of the power transmitter 110 is controlled based on a result of the determination. It is thus possible to determine whether or not the power receiver 210 is performing the restriction control without continuous communication with the power receiver. And it is possible to reduce the period during which the power receiver 210 performs the restriction control. Consequently, it is possible to reduce a decrease in power efficiency and a heat loss caused by the switching control. Furthermore, it is possible to achieve cost reduction and downsizing of the power receiver 210.

In the above, the wireless power transmission system using resonant inductive coupling has been described. The wireless power transmission system according to the present embodiment can be similarly applied to other forms such as a wireless power transmission system using electromagnetic induction.

What is claimed is:

1. A control apparatus for a power transmitter which wirelessly transmits electric power to a power receiver,
the power receiver being configured to perform restriction control that restricts received power through switching control under a predetermined condition,
the control apparatus being configured to execute:
a determination process that determines whether or not the power receiver is performing the restriction control based on an output current and an output voltage of a power inverter included in the power transmitter; and
a power control process that controls transmission power of the power transmitter based on a result of the determination process.

2. The control apparatus according to claim 1,
wherein the determination process comprises:
calculating an amplitude ratio and a phase difference between the output current and the output voltage; and
determining that the power receiver is performing the restriction control when a coordinate position represented by a pair of the amplitude ratio and the phase difference is outside a predetermined range.

3. The control apparatus according to claim 2, further configured to execute:
a process that acquires specification information and identification information of the power receiver predicted to become a power transmission target; and
a process that identifies the power receiver being the power transmission target based on the identification information before starting power transmission,
wherein the determination process further comprises determining the predetermined range based on the specification information of the identified power receiver.

4. The control apparatus according to claim 1,
wherein the power control process comprises performing control to reduce the transmission power when it is determined that the power receiver is performing the restriction control.

5. A control method for controlling a power transmitter which wirelessly transmits electric power to a power receiver,
the power receiver being configured to perform restriction control that restricts received power through switching control under a predetermined condition,
the control method comprises:
determining whether or not the power receiver is performing the restriction control based on an output current and an output voltage of a power inverter included in the power transmitter; and
controlling transmission power of the power transmitter based on a result of the determining whether or not the power receiver is performing the restriction control.

6. The control method according to claim 5,
wherein the determining whether or not the power receiver is performing the restriction control comprises:
calculating an amplitude ratio and a phase difference between the output current and the output voltage; and
determining that the power receiver is performing the restriction control when a coordinate position represented by a pair of the amplitude ratio and the phase difference is outside a predetermined range.

7. A non-transitory computer readable recording medium on which a control program for controlling a power transmitter which wirelessly transmits electric power to a power receiver is recorded,
the power receiver being configured to perform restriction control that restricts received power through switching control under a predetermined condition,
the control program, when executed by a computer, causing the computer to execute:
a determination process that determines whether or not the power receiver is performing the restriction control based on an output current and an output voltage of a power inverter included in the power transmitter; and
a power control process that controls transmission power of the power transmitter based on a result of the determination process.

8. The non-transitory computer readable recording medium according to claim 7,
wherein the determination process comprises:
calculating an amplitude ratio and a phase difference between the output current and the output voltage; and
determining that the power receiver is performing the restriction control when a coordinate position represented by a pair of the amplitude ratio and the phase difference is outside a predetermined range.
